(19) United States
(12) Patent Application Publication
(10) Pub. No.: US 2026/0195107 A1
(43) Pub. Date: Jul. 9, 2026

(54) DYNAMIC CONTAINER DEPENDENCY MANAGEMENT

(71) Applicant: INTERNATIONAL BUSINESS MACHINES CORPORATION, ARMONK, NY (US)

(72) Inventors: Yu Zui You, Ningbo (CN); Zhan Peng Huo, Beijing (CN); Xiao Ling Chen, Beijing (CN); Heng Wang, Beijing (CN)

(21) Appl. No.: 19/008,690

(22) Filed: Jan. 3, 2025

(51) Int. Cl. G06F 8/41; G06F 9/445; G06F 9/455; G06F 11/14

(52) U.S. Cl. CPC G06F 8/433; G06F 9/44505; G06F 9/45533; G06F 11/1405

(57) ABSTRACT

Container dependency management is provided. The container dependency management includes identifying a software service process file for a container at runtime, comparing the software service process file to a dependency management file for the container to identify one or more unreferenced dependencies, deleting the one or more unreferenced dependencies from the container, and in response to identifying a run error related to a first deleted dependency of the one or more unreferenced dependencies, rolling back deletion of the first deleted dependency.

### BACKGROUND

The present disclosure relates to containerization, and more particularly to container dependency management.

Containers encapsulate an application and its dependencies, allowing consistent operation across different computing environments. However, as containerized applications evolve over time, their dependency management can become complex. Unused or outdated dependencies may accumulate, increasing container size and potentially introducing security vulnerabilities. Developers often struggle to accurately identify and remove unnecessary dependencies, especially when working with legacy code or on collaborative projects. Additionally, the fast-paced nature of software development can lead to neglect of regular dependency maintenance. These issues can result in increased container size, reduced performance, additional resource consumption, and increased security risks.

### SUMMARY

According to an aspect of the present disclosure, a method for container dependency management is provided. The method includes identifying a software service process file for a container at runtime. The method further includes comparing the software service process file to a dependency management file for the container to identify one or more unreferenced dependencies. The method also includes deleting the one or more unreferenced dependencies from the container. Additionally, in response to identifying a run error related to a first deleted dependency of the one or more unreferenced dependencies, the method includes rolling back deletion of the first deleted dependency.

According to another aspect of the present disclosure, a system for container dependency management is provided. The system includes one or more processors and one or more memories configured to perform operations. The operations include identifying a software service process file for a container at runtime. The operations further include comparing the software service process file to a dependency management file for the container to identify one or more unreferenced dependencies. The operations further include deleting the one or more unreferenced dependencies from the container. The operations further include, in response to identifying a run error related to a first deleted dependency of the one or more unreferenced dependencies, rolling back deletion of the first deleted dependency.

According to another aspect of the present disclosure, a computer program product for container dependency management is provided. The computer program product includes a computer-readable storage medium having program instructions embodied therewith. The program instructions are executable by a processor to cause the processor to perform operations. The operations include identifying a software service process file for a container at runtime. The operations further include comparing the software service process file to a dependency management file for the container to identify one or more unreferenced dependencies. The operations further include deleting the one or more unreferenced dependencies from the container. The operations further include, in response to identifying a run error related to a first deleted dependency of the one or more unreferenced dependencies, rolling back deletion of the first deleted dependency.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a computing environment for executing container dependency management, according to aspects of the present disclosure.

FIG. 2 depicts a block diagram of a container dependency management module, according to an embodiment.

FIG. 3 shows a flowchart of a method for container dependency management, in accordance with example embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to dynamic container dependency management, and more particular aspects relate to deleting unused dependencies and updating risky dependencies. While the present disclosure is not necessarily limited to such applications, various aspects of the disclosure may be appreciated through a discussion of various examples using this context.

Containerization is a virtualization technology that allows applications and their dependencies to be packaged together in isolated environments called containers. These containers can run consistently across different computing platforms, from development machines to production servers, without modification.

In containerization, the application code, runtime, system tools, libraries, and settings are bundled together in a container image. This image can then be used to create multiple instances of the containerized application, each running in its own isolated environment but sharing the host system's operating system kernel.

Containers offer several advantages over traditional virtualization methods. They are more lightweight, as they do not require a full operating system for each instance. This results in faster startup times, reduced resource consumption, and improved density of applications per host. Containers also provide better isolation between applications, enhancing security and reducing conflicts between different software components.

Popular containerization platforms, such as Docker, have gained widespread adoption in software development and deployment workflows. These platforms provide tools for creating, distributing, and managing containers, facilitating easier application deployment and scaling.

In containerized environments, dependencies play a crucial role. Dependencies are external software components, libraries, or packages that an application relies on to function properly. By including these dependencies within the container, developers can ensure that the application has access to all necessary resources, regardless of the host environment.

As containerization continues to evolve, new challenges and opportunities arise in areas such as orchestration, security, and dependency management. Container orchestration platforms, like Kubernetes, have emerged to manage the deployment, scaling, and operation of container clusters. These platforms address complex scenarios involving multiple containers and hosts, enabling more efficient use of computing resources and facilitating the implementation of microservices architectures.

Containerized environments may utilize software packages and libraries, referred to as dependencies, to support the functionality of applications running within containers. As containerized applications evolve and update over time, some dependencies may become unnecessary or outdated. In some cases, retaining unused or outdated dependencies in containers may lead to increased container size, potential security vulnerabilities, and inefficient resource utilization.

Python, a popular high-level programming language, is widely used in containerization environments. In the context of container dependency management, Python offers several tools and libraries that may facilitate the creation and maintenance of containerized applications. For instance, the ‘equirements.txt’ file in Python projects may be used to specify and manage dependencies, which can be easily integrated into container build processes. Python's package management system, pip, may be utilized to install and manage these dependencies within containers. Additionally, Python frameworks such as Flask and Django may be containerized, allowing developers to create lightweight, portable web applications. In some cases, Python scripts may be employed to automate container-related tasks, including dependency analysis and management, further streamlining the containerization workflow.

Embodiments of the present disclosure relate to methods, systems, and computer program products for performing dynamic container dependency management. Dynamic container dependency management may involve analyzing, removing, and updating the dependencies of software containers while they are running to reduce container size, reduce resource consumption, enhance security, and improve overall performance.

Embodiments of the present disclosure may address these challenges by providing dynamic container dependency management. In some embodiments, the runtime processes of containers are analyzed to determine which dependencies are actively used. This information may be compared with the declared dependencies in configuration files to identify unused or unnecessary dependencies. In some embodiments, unused dependencies are automatically removed from containers, potentially reducing container size and minimizing potential security risks associated with unnecessary software components.

In some embodiments, dependencies that may pose security risks due to known vulnerabilities or outdated versions are identified. Risky dependencies may be updated to more secure versions.

In some embodiments, operational errors are monitored for errors related to deleted or updated dependencies. Dependency removals or updates that cause operational errors may be rolled back to correct for actions that negatively impact container functionality.

By providing dynamic container dependency management, embodiments of the present disclosure may provide for improved efficiency and security of containerized environments during runtime.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as container dependency management module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

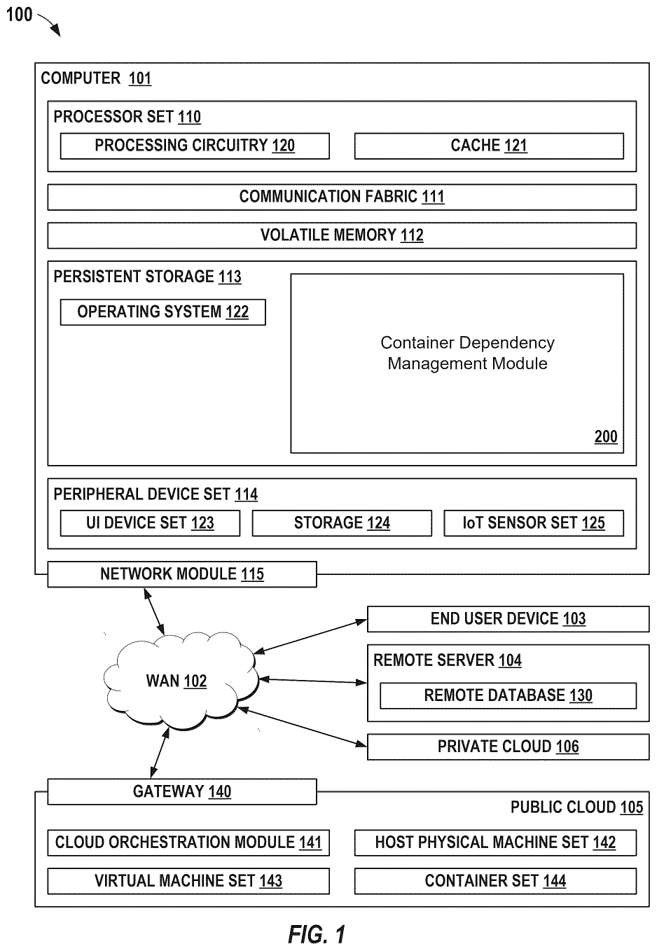

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

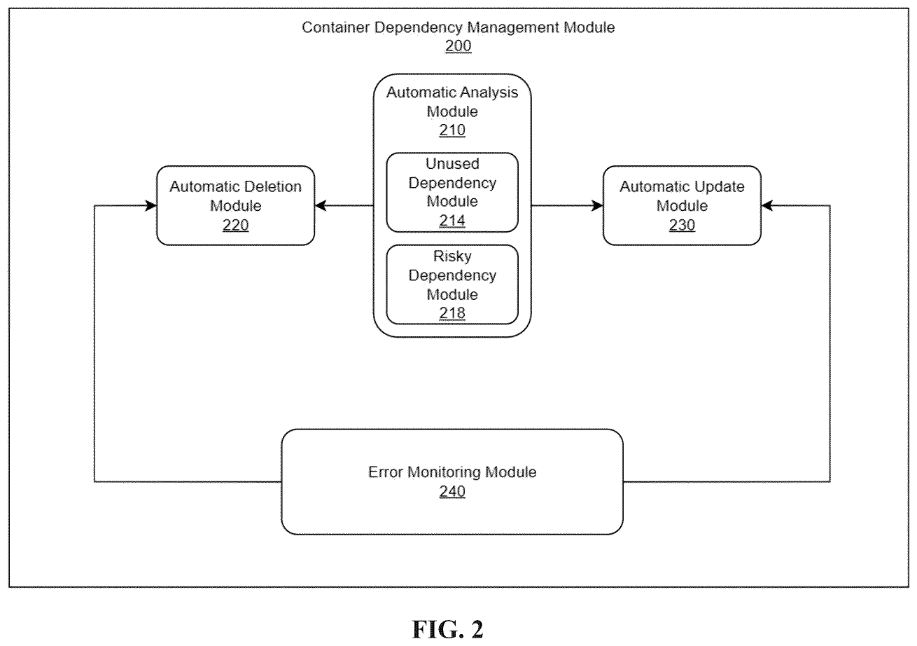

Referring now to FIG. 2, an example block diagram of a container dependency management module 200 is depicted.

The container dependency management module 200 may include an automatic analysis module 210. In some cases, the automatic analysis module 210 may obtain a software service process file for a container at runtime. The automatic analysis module 210 may also obtain a dependency management file, such as a requirements. txt file, which lists the declared dependencies for the container.

In some embodiments, the automatic analysis module 210 may include an unused dependency module 214 and a risky dependency module 218. The unused dependency module 214 may identify unused dependencies by comparing the software service process file to the dependency management file. Dependencies listed in the dependency management file but not present in the software service process file may be identified as unused.

The risky dependency module 218 may identify risky dependencies and associated updates. In some cases, the risky dependency module 218 may run used dependencies through an existing Security Monitoring tool such as Contrast Scan or AppScan to identify potential security risks and available updates.

The container dependency management module 200 may also include an automatic deletion module 220. The automatic deletion module 220 may delete unused dependencies identified by the automatic analysis module 210. In some embodiments, the automatic deletion module 220 may interact with a Kubernetes operator or other container environment controller to dynamically delete dependencies from running containers.

An automatic update module 230 may also be included in the container dependency management module 200. The automatic update module 230 may update risky dependencies to updated versions identified by the risky dependency module 218. Similar to the automatic deletion module 220, the automatic update module 230 may interact with a Kubernetes operator or other container environment controller to dynamically update dependencies in running containers.

In some embodiments, the container dependency management module 200 may include an error monitoring module 240. The error monitoring module 240 may monitor for errors related to dependencies and notify the automatic deletion module 220 and automatic update module 230 to allow them to roll back deletions and updates that cause errors. In some cases, the error monitoring module 240 may monitor error logs. In other cases, the error monitoring module 240 may call a unit test (UT) to identify errors based on deletions or updates.

The container dependency management module 200 may be configured to generate reports on actions taken for an operations and maintenance (O&M) team. These reports may include information on deleted dependencies, updated dependencies, and any rollbacks performed.

It should be noted that different embodiments of the container dependency management module 200 may contain more or fewer modules than those described. In some cases, certain modules may be combined or their functions distributed among other modules. The specific configuration and arrangement of modules may vary depending on the particular implementation and requirements of the containerized environment.

The container dependency management module 200 depicted in FIG. 2 may be implemented within the computing environment 100 shown in FIG. 1. In some aspects, module 200 may be stored in persistent storage 113 of computer 101 and executed by processor set 110. The module 200 may interact with containers from container set 144 running in public cloud 105 or private cloud 106. In some cases, the automatic analysis module 210 may obtain software service process files and dependency management files from containers via network module 115 and WAN 102. The automatic deletion module 220 and automatic update module 230 may communicate with cloud orchestration module 141 to manage container dependencies. Additionally, the error monitoring module 240 may interface with logging and monitoring systems within the cloud environments to detect and respond to dependency-related errors.

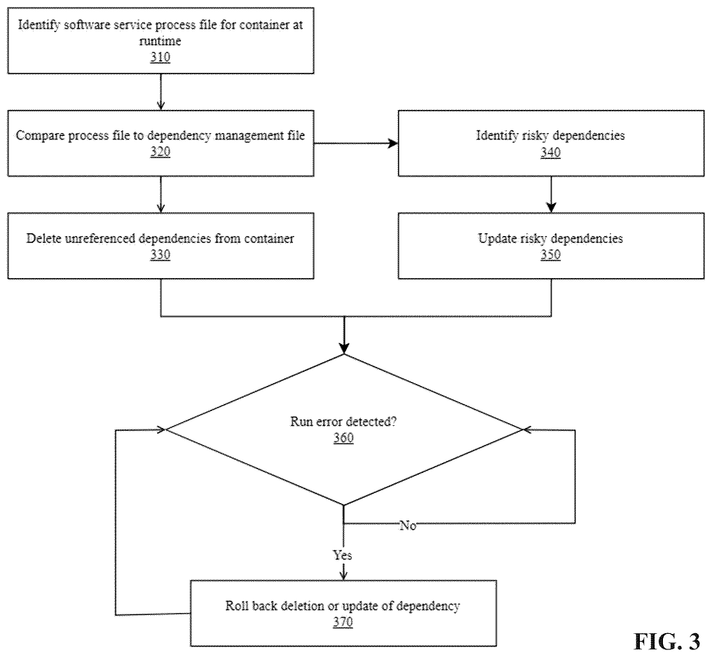

Referring now to FIG. 3, a flowchart of an example method 300 for container dependency management is depicted.

The method 300 may begin with operation 310 where a software service process file for a container may be identified at runtime. For example, an lsof (List Open Files) command may be used to produce the following:
COMMAND PID USER FD TYPE DEVICE SIZE/OFF NODE NAME
python3 12345 user mem REG 253,0 102400 20444
/usr/lib/python3.8/site-packages/numpy/core/_multiarray_umath.cpython-38-x86_64-linux-gnu.so
python3 12345 user mem REG 253,0 20480 21044
/usr/lib/python3.8/site-packages/pandas/_libs/algos.cpython-38-x86_64-linux-gnu.so
python3 12345 user mem REG 253,0 8192 22550
/usr/lib/python3.8/site-packages/pandas/io/parsers.py
python3 12345 user mem REG 253,0 102400 30100
/usr/lib/python3.8/site-packages/scipy/sparse/csr.cpython-38-x86_64-linux-gnu.so

In operation 320, the software service process file may be compared to a dependency management file for the container. For example, the following entries may be identified from a requirements. txt file:
numpy==1.21.2
pandas==1.3.3
Scipy==1.7.1

The comparison may be used to identify one or more unreferenced dependencies. In some cases, dependencies listed in the dependency management file but not present in the software service process file may be identified as unreferenced dependencies.

In an operation 330, one or more unreferenced dependencies may be deleted from the container. In some cases, the one or more unreferenced dependencies may be deleted via an operator of a container management system. The operator may be a Kubernetes operator in some embodiments.

In an operation 340, one or more risky dependencies in the container may be identified. In some cases, a list of used dependencies may be analyzed using a risk analysis tool to identify updated versions for the one or more risky dependencies. The risk analysis tool may identify a risky dependency and indicate a target version for upgrading the dependency. For example, the risk analysis tool may provide the following:
{“package”:“pandas”,“version”:“1.2.3”, “status”:“risk”,“target version”:“1.3.4”}
In operation 350, the one or more risky dependencies may be updated. For example, a dependency may be updated via a Kubernetes operator:
{“package”:“pandas”,“version”:“1.3.4”, “status”:“risk”,“action”:“updated”}

In the operation 360, a check may be performed to determine if a run error is detected. In some cases, operation error logs may be monitored to detect runtime errors.

If a run error is detected, the method 300 may proceed to operation 370. In operation 370, the deletion or update of a dependency may be rolled back. In some cases, if a run error related to a specific deleted dependency, the deletion of the first deleted dependency may be rolled back. The dependency that was deleted may be reinstalled in the container. For example:
pip install pandas==1.2.3

Similarly, if an error related to a first updated dependency of the updated one or more risky dependencies is identified, the first updated dependency may be rolled back to a previous version. For example:
pip install—pgrade pandas==1.2.3

The deletions and updates of dependencies may be recorded, such that a when an error related to a dependency is detected, the record may be referenced to identify an associated deletion or update.

The method 300 may provide a comprehensive approach to managing container dependencies, addressing both unused and potentially risky dependencies while incorporating error detection and correction mechanisms. By dynamically managing dependencies during runtime, the method 300 may contribute to improved efficiency and security of containerized environments.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for container dependency management, the method comprising:
identifying a software service process file for a container at runtime;
comparing the software service process file to a dependency management file for the container to identify one or more unreferenced dependencies;
deleting the one or more unreferenced dependencies from the container; and
in response to identifying a run error related to a first deleted dependency of the one or more unreferenced dependencies, rolling back deletion of the first deleted dependency.

2. The method of claim 1, wherein identifying one or more unreferenced dependencies comprises:
identifying dependencies listed in the dependency management file but not present in the software service process file.

3. The method of claim 1, wherein deleting the one or more unreferenced dependencies comprises:
deleting the one or more unreferenced dependencies via an operator of a container management system.

4. The method of claim 3, wherein the operator is a Kubernetes operator.

5. The method of claim 1, further comprising:
identifying one or more risky dependencies in the container;
updating the one or more risky dependencies; and
in response to identifying an error related to a first updated dependency of the updated one or more risky dependencies, rolling back the first updated dependency to a previous version.

6. The method of claim 5, wherein identifying one or more risky dependencies comprises:
analyzing a list of used dependencies using a risk analysis tool to identify updated versions for the one or more risky dependencies.

7. The method of claim 5, further comprising:
generating a report based on the deleted dependencies, updated dependencies, and rollbacks.

8. The method of claim 1, wherein identifying a run error related to the first dependency comprises:
monitoring operation error logs;
identifying the first dependency as related to a detected error; and
determining that the first dependency was deleted.

9. A system for container dependency management, comprising:
one or more processors; and
one or more memories configured to perform operations comprising:
identifying a software service process file for a container at runtime;
comparing the software service process file to a dependency management file for the container to identify one or more unreferenced dependencies;
deleting the one or more unreferenced dependencies from the container; and
in response to identifying a run error related to a first deleted dependency of the one or more unreferenced dependencies, rolling back deletion of the first deleted dependency.

10. The system of claim 9, wherein identifying one or more unreferenced dependencies comprises:
identifying dependencies listed in the dependency management file but not present in the software service process file.

11. The system of claim 9, wherein deleting the one or more unreferenced dependencies comprises:
deleting the one or more unreferenced dependencies via an operator of a container management system.

12. The system of claim 11, wherein the operator is a Kubernetes operator.

13. The system of claim 9, wherein the operations further comprise:
identifying one or more risky dependencies in the container;
updating the one or more risky dependencies; and
in response to identifying an error related to a first updated dependency of the updated one or more risky dependencies, rolling back the first updated dependency to a previous version.

14. The system of claim 13, wherein identifying one or more risky dependencies comprises:
analyzing a list of used dependencies using a risk analysis tool to identify updated versions for the one or more risky dependencies.

15. The system of claim 13, wherein the operations further comprise:
generating a report based on the deleted dependencies, updated dependencies, and rollbacks.

16. The system of claim 9, wherein identifying the run error related to the first dependency comprises:
monitoring operation error logs;
identifying the first dependency as related to a detected error; and
determining that the first dependency was deleted.

17. A computer program product for container dependency management, comprising a computer-readable storage medium having program instructions embodied therewith, the program instructions executable by a processor to cause the processor to perform operations comprising:
identifying a software service process file for a container at runtime;
comparing the software service process file to a dependency management file for the container to identify one or more unreferenced dependencies;
deleting the one or more unreferenced dependencies from the container; and
in response to identifying a run error related to a first deleted dependency of the one or more unreferenced dependencies, rolling back deletion of the first deleted dependency.

18. The computer program product of claim 17, wherein identifying one or more unreferenced dependencies comprises:
identifying dependencies listed in the dependency management file but not present in the software service process file.

19. The computer program product of claim 17, wherein deleting the one or more unreferenced dependencies comprises:
deleting the one or more unreferenced dependencies via an operator of a container management system.

20. The computer program product of claim 17, wherein the operations further comprise:
identifying one or more risky dependencies in the container;
updating the one or more risky dependencies; and
in response to identifying an error related to a first updated dependency of the updated one or more risky dependencies, rolling back the first updated dependency to a previous version.
